(19) United States
(12) Patent Application Publication
(10) Pub. No.: US 2016/0033106 A1
(43) Pub. Date: Feb. 4, 2016

(54) LIGHT SOURCE DEVICE

(71) Applicant: CANON KABUSHIKI KAISHA, Tokyo (JP)

(72) Inventor: Yasuhiro Matsuura, Yokohama-shi (JP)

(21) Appl. No.: 14/809,385

(22) Filed: Jul. 27, 2015

(30) Foreign Application Priority Data
Aug. 1, 2014 (JP) 2014-157553
Jun. 26, 2015 (JP) 2015-128893

(51) Int. Cl. F21V 3/04; G02F 1/1335

(52) U.S. Cl. CPC F21V 3/049; G02F 1/133606

(57) ABSTRACT

A light source device comprises a plurality of kinds of light sources having different directivity characteristics and including a first light source and a second light source having a directivity characteristic wider than a directivity characteristic of the first light source; and a diffusing structure section for radiating light emitted by the first light source after diffusing the light, wherein a position of a center of a first brightness distribution of light radiated from the diffusing structure section in a case when the first light source emits light is a position corresponding to a position of a center of a second brightness distribution in a case when the second light source emits light.

### BACKGROUND OF THE INVENTION

1. Field of the Invention

The present invention relates to a light source device.

2. Description of the Related Art

In a light source device, in particular, a backlight device for a liquid crystal display apparatus, there is a method of realizing a wide color gamut corresponding to a display color of a video signal using a structure obtained by combining light emitting diodes (hereinafter, LEDs) of red, green, and blue. However, in the case of the backlight device for the liquid crystal display apparatus including the LEDs of red, green, and blue, there is a limit in expansion of a display color gamut because of a relation between spectral characteristics of the LEDs and transmission characteristics of a liquid crystal display panel. For example, when all of the LEDs of red, green, and blue of the backlight device are lit and only a green color filter of the liquid crystal display panel is set to transmit light, components of red and blue are sometimes slightly transmitted through the green color filter of the liquid crystal panel. The components of red and blue are transmitted because the spectral characteristics of the LEDs are half-value width of approximately 30 nm. Because of the influence of the transmission of the red and blue components, the purity of the light transmitted through the green color filter is further deteriorated than when only the green LED is lit. This makes it impossible to expand the color gamut of the liquid crystal display device. Therefore, a backlight device including laser diodes as devices that can emit beams of light having color purity higher than the color purity of beams of light emitted by the LEDs has started to be examined (e.g., Japanese Patent Application Laid-Open No. 2011-238484). However, since the laser diodes are expensive in general, a backlight device for attaining both of cost effectiveness and performance such as a light source device obtained by combining the laser diodes and the LEDs as described in Japanese Patent Application Laid-Open No. 2012-238462 is also examined.

On the other hand, there is a technique for, making use of the fact that the LEDs and the laser diodes are point light sources, partially changing brightness of a backlight device for a liquid crystal display apparatus and increasing the contrast of a displayed image by individually controlling light emission brightness of the point light sources. The method of individually controlling the light emission brightness in this way is generally called local dimming control. In the local dimming control, concerning each of a plurality of divided regions configuring a display screen, processing for analyzing a brightness value of an image signal and controlling light emission brightness of a light source corresponding to the divided region on the basis of an analysis result of the brightness value is performed. Consequently, the contrast of the displayed image is improved. As the backlight device in which the local dimming control is performed, a structure called a downright type in general is often used. However, there is a concern that the backlight device is increased in thickness in the downright type structure. As a related art for solving this concern, for example, there is a technique described in Japanese Patent Application Laid-Open No. 2012-174634.

### SUMMARY OF THE INVENTION

However, when the local diming control is performed in the light source device including both of the LEDs and the laser diodes, a difference between directivities of both the light sources is a problem. This problem means that it is extremely difficult to match a brightness distribution and a chromaticity distribution because, in most of the LEDs, a half-value angle of the directivity is 120 degrees and, on the other hand, in the laser diodes, a half-value angle of the directivity is approximately 0 degrees to 30 degrees. Because of this problem, when the LEDs and the laser diodes are lit at different brightness for each of the divided regions by the local dimming control, unevenness easily occurs in the chromaticity distribution.

The present invention has been devised in view of the circumstances explained above and it is an object of the present invention to uniformize, in a light source device configured by a plurality of kinds of light sources, a chromaticity distribution of the light source device even when light source brightness is switched for each of divided regions by local dimming control.

To achieve above-mentioned object, the present invention provides a light source device comprising: a plurality of kinds of light sources having different directivity characteristics and including a first light source and a second light source having a directivity characteristic wider than a directivity characteristic of the first light source; and a diffusing structure section for radiating light emitted by the first light source after diffusing the light, wherein a position of a center of a first brightness distribution of light radiated from the diffusing structure section in a case when the first light source emits light is a position corresponding to a position of a center of a second brightness distribution in a case when the second light source emits light.

According to the present invention, it is possible to uniformize, in the light source device configured by the plurality of kinds of light sources, a chromaticity distribution of the light source device even when light source brightness is switched for each of divided regions by the local dimming control.

Further features of the present invention will become apparent from the following description of exemplary embodiments with reference to the attached drawings.

### BRIEF DESCRIPTION OF THE DRAWINGS

FIG. 1 is a diagram showing the schematic configuration of a main part of a light source device according to a first embodiment;

FIG. 2 is a diagram showing an A-A cross section of FIG. 1;

FIG. 3 is a diagram showing a brightness distribution of the light source device according to the first embodiment; and

FIG. 4 is a diagram showing the schematic configuration of a main part of a light source device according to a second embodiment.

### DESCRIPTION OF THE EMBODIMENTS

Modes for carrying out the present invention are illustratively explained in detail below with reference to the drawings.

### First Embodiment

A light source device according to a first embodiment of the present invention is explained.

The light source device according to this embodiment is a light source device in which local dimming control can be performed. The light source device includes a plurality of divided regions (light emitting blocks) in which light emission brightness can be individually changed. With one or more divided regions set as one light emission unit, the light source device is configured to be capable of emitting light at determined light emission brightness for each light emission unit. The light source device according to this embodiment can be used as, for example, a backlight device for a liquid crystal display apparatus. Note that the present invention can be suitably applied to not only the backlight device but also, for example, a light source device of a display apparatus (an advertisement sign apparatus, a sign display apparatus, etc.) that transmits light and displays an image. The present invention can also be suitably applied to a light source device for an apparatus other than the display apparatus such as an indoor light or a streetlight.

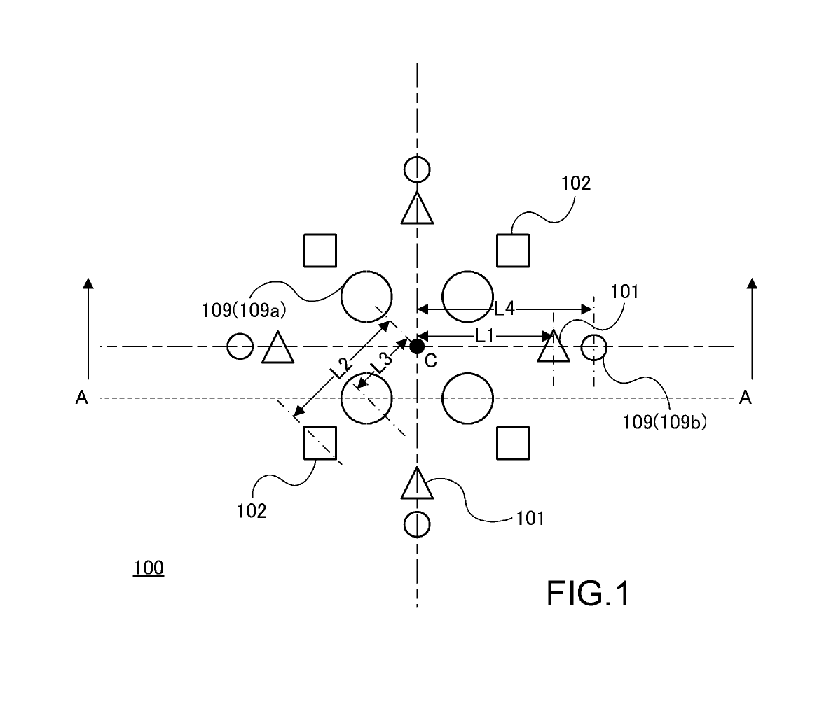

FIG. 1 is a diagram showing the schematic configuration of a main part of a light source device 100 according to this embodiment. In FIG. 1, one lighting unit (light emission unit) of the light source device 100 is shown.

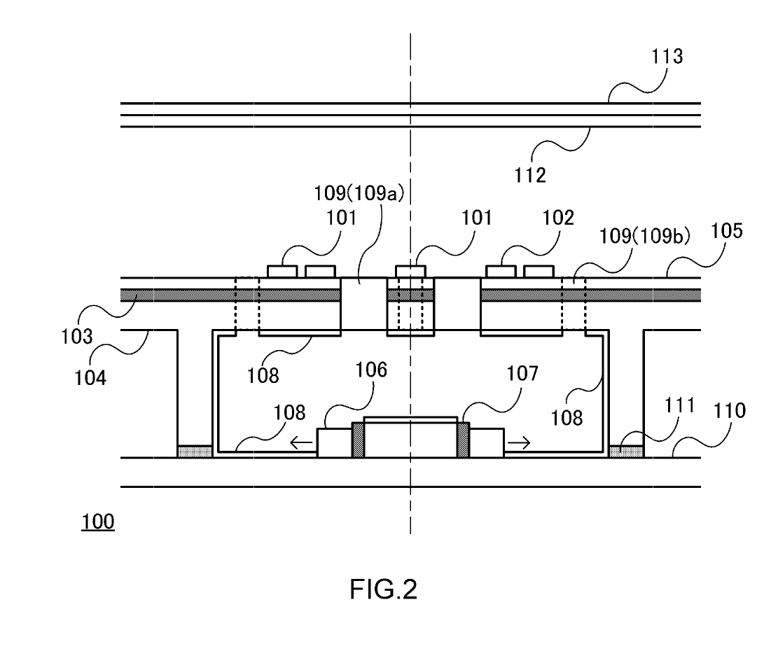

FIG. 2 is a diagram showing an A-A cross section of FIG. 1 (a sectional view of a portion cut by a dotted line viewed in an arrow direction).

The configuration of the light source device 100 is explained below with reference to FIGS. 1 and 2.

A light source 101 is a blue light emitting diode (LED) light source. The light source 101 in this embodiment is disposed to radiate light in the direction of a diffusing section 112 explained below. A plurality of light sources 101 may be disposed or one light source 101 may be disposed with respect to one lighting unit.

A light source 102 is a red LED light source. The light source 102 in this embodiment is disposed to irradiate light in the direction of the diffusing section 112 as in the light source 101. A plurality of light sources 102 may be disposed or one light source 102 may be disposed with respect to one lighting unit.

A substrate section 103 is a mounting substrate for transmitting electric power necessary for the light source 101 and the light source 102 to emit beams of light. The substrate section 103 may be a general glass epoxy substrate or may be an aluminum substrate excellent in heat radiation properties.

A heat radiating section 104 is a heat radiating structure for efficiently cooling heat generated in a case when the light source 101 and the light source 102 emit beams of light and lighting the light source 101 and the light source 102 at predetermined temperature or less. Note that an insulation sheet having an electric insulation effect may be arranged (inserted) between the substrate section 103 and the heat radiating section 104.

A reflecting section 105 is a light reflecting plate for improving a rate of use of beams of light emitted by the light source 101, the light source 102, and a light source 106 explained below. The reflecting section 105 plays a role of increasing reflection efficiency in returning, to the diffusing section 112 side, beams of light reflected by the diffusing section 112 and a liquid crystal display panel 113 among the beams of light emitted by the light source 101, the light source 102, and the light source 106.

The light source 106 is a green laser diode. The light source 106 in this embodiment is attached to emit light in a direction 90 degrees different from the light emitting directions of the light source 101 and the light source 102. However, the light source 106 may be attached to emit light in the direction of the diffusing section 112 like the light source 101 and the light source 102.

A substrate section 107 is a mounting substrate for transmitting electric power necessary for the light source 106 to emit light. The substrate section 107 may be a general glass epoxy substrate or may be an aluminum substrate excellent in heat radiation properties.

Reflecting sections 108 configure a reflecting structure (a diffusing structure) for sufficiently diffusing the light emitted by the light source 106 in a substantially closed space surrounded by the reflecting sections 108. In this embodiment, the substantially closed space is configured by the heat radiating section 104 and a heat radiating section 110 explained below. The reflecting sections 108 are disposed in a side surface section, a bottom surface section, and a ceiling surface section in the substantially closed space. However, the reflecting sections 108 are not limited to this disposition. Setting surfaces of the reflecting sections 108 only have to be set as appropriate according to necessary diffusion performance. Since the reflecting sections 108 are disposed in the side surface section, the bottom surface section, and the ceiling surface section of the substantially closed space, it is possible to increase a rate of use of emitted light. Since the heat radiating section 104 configures a part of the reflecting structure (the diffusing structure) configured by the reflecting sections 108 (the heat radiating section 104 also functions as the reflecting structure), it is possible to reduce the size of an optical device main body.

Light-transmitting hole sections 109 are holes (radiation holes) for radiating the light emitted by the light source 106 in the direction of the diffusing section 112 (to the outside of the diffusing structure) after diffusing the light using the substantially closed space configured by the reflecting sections 108. In the light-transmitting hole sections 109, a diffusing structure such as a diffusing plate (a diffusing member) may be additionally set according to brightness distribution performance of the beams of light radiated from the light-transmitting hole sections 109 to improve unevenness adjusting performance of a brightness distribution.

A heat radiating section 110 is a heat radiating structure for efficiently cooling heat generated in a case when the light source 106 emits light and lighting the light source 106 at predetermined temperature or less. An insulation sheet having an electric insulation effect may be disposed between the substrate section 107 and the heat radiating section 110.

A heat insulating section 111 is a structure for suppressing heat conduction of the heat radiating section 104 and the heat radiating section 110. The heat insulating section 111 may be a sheet-like structure, may be a rubber-like structure, or may be a space.

A diffusing section 112 is a diffusing structure for radiating the beams of light emitted by the light source 101, the light source 102, and the light source 106 to the liquid crystal display panel 113 after sufficiently diffusing the beams of light. Examples of a member used as the diffusing section 112 include a diffusing plate, a diffusing sheet, a light collecting sheet, and a light polarizing sheet. The diffusing section 112 is configured by the member alone or a combination of a plurality of sheet.

The liquid crystal display panel 113 is a panel that receives a video signal transmitted from a video signal apparatus and displays a video corresponding to content of the video signal.

The dispositions of the light source 101, the light source 102, the light source 106, and the light-transmitting hole sections 109 in the light source device 100 according to this embodiment are explained.

The disposition of the light source 106 is determined to radiate the light from the light source 106 in a desired brightness distribution when the light is radiated from the light-transmitting hole sections 109 after being sufficiently diffused in the reflecting sections 108 (in the diffusing structure). In this embodiment, as shown in FIG. 2, a radiating direction of the light of the light source 106 is set in the horizontal direction (an arrow direction shown in the figure). This is because, if the light source 106 is disposed such that the light from the light source 106 is radiated in the vertical direction, it is highly likely that the beams light radiated from the light-transmitting hole sections 109 are radiated in a state in which the lights are not sufficiently diffused. Although not shown in the figure, a light diffusing body such as a lens may be provided in the radiating direction of the light in order to urge the diffusion of the light from the light source 106.

The disposition of the light source 101 and the light source 102 is explained.

In this embodiment, the light source 101 is an LED. Four light sources 101 are disposed in one lighting unit. The four light sources 101 are simultaneously lit. The four light sources 101 are lit at the same brightness. At this point, a brightness distribution shape formed by the simultaneously lighting the four light sources 101 is a distribution shape in which brightness is the highest at a center point C of the lighting unit.

The brightness distribution is formed as explained above because the four light sources 101 are disposed on the substrate section 103 at the same interval L1 with respect to the center point C of the lighting unit (disposed on the circumference of a circle (an imaginary circle) centering on the center point C). The four light sources 101 are more desirably disposed at an equal interval in the circumferential direction of the circle centering on the center point C.

The center point C shown in FIG. 1 is an imaginary point on a surface (on a substrate) on a mounting side on which the light source 101 and the light source 102 are mounted in the substrate section 103. A diagram of the light source device 100 viewed in a direction orthogonal to the substrate surface is FIG. 1.

Like the light sources 101, four light sources 102 are disposed in one lighting unit. The four light sources 102 are simultaneously lit. The four light sources 102 are lit at the same brightness. At this point, since the four light sources 102 are disposed at the same interval L2 with respect to the center point C of the lighting unit, a brightness distribution shape formed by simultaneously lighting the four light sources 102 is a distribution shape in which brightness is the highest at the center point C of the lighting unit. Since the brightness distribution shapes of both of the light sources 101 and the light sources 102 is the distribution shape in which the brightness is the highest at the center point C of the lighting unit, a brightness distribution shape formed in a case when the light sources 101 and the light sources 102 are simultaneously lit is also the brightness distribution shape in which the brightness is also the highest at the center point C of the lighting unit.

The disposition of the light-transmitting hole sections 109 is examined.

The light-transmitting hole sections 109 are transmitting holes (radiating holes) or diffusing structures for radiating the light from the light source 106 in the direction of the diffusing section 112 as explained above. The light-transmitting hole sections 109 in this embodiment are configured by large four holes and small four holes. Large holes 109a are disposed at an interval L3 from the center point C. Small holes 109b are disposed at an interval of L4 from the center point C. As shown in FIG. 1, the interval L3 and the interval L4 are in a relation of L3<L4.

If the sizes of the light transmitting holes of the light-transmitting hole sections 109 are the same, the light transmitting holes can be regarded as point light sources that are lit at the same brightness. This is because, since the light from the light source 106 is sufficiently diffused in the reflecting sections 108, light irradiated on the upper surface section of the reflecting sections 108 is in a uniform state.

Uniformization of a chromaticity distribution during local dimming control, which is the purpose of the present invention is examined.

To uniformize the chromaticity distribution, a distribution shape of a brightness distribution of the beams of light from the light-transmitting hole sections 109 only has to be formed in a shape corresponding to a distribution shape of a brightness distribution of the lights emitted by the light source 101 and the light source 102. To form the distribution shape, the position of the center of the brightness distribution of the beams of light from the light-transmitting hole sections 109 only has to be a position corresponding to the position of the center of the brightness distribution of the beams of light emitted by the light source 101 and the light source 102. More specifically, the distribution shapes of the brightness distributions of the beams of light from the light source 101, the light source 102, and the light-transmitting hole sections 109 only have to be approximated (substantially matched). Therefore, as the disposition of the light-transmitting hole sections 109, the light-transmitting hole sections 109 only have to be disposed centering on the center point C at substantially equal intervals from the center point C such that brightness is the highest at the center point C of the lighting unit. The light-transmitting hole sections 109 are more desirably disposed at an equal interval in the circumferential direction of the circle centering on the center point C.

Further, to approximate the brightness distribution shapes of the light source 101, the light source 102, and the light-transmitting hole sections 109 in portions other than the center point C, it is ideal to equalize intervals between the light sources, the light-transmitting hole sections, and the center point C. That is, it is ideal to equalize the interval L1 between the light source 101 and the center point C, the interval L2 between the light source 102 and the center point C, and the intervals L3 and L4 between the light-transmitting hole sections 109 and the center point C.

When there is a problem of space in the disposition of the light sources and the disposition of the transmitting holes, the sizes of the light-transmitting hole sections 109 only have to be changed according to an interval from the center point C such that the brightness distributions of the beams of light emitted by the light sources are approximated. In FIG. 1, an example is shown in which the sizes of the light-transmitting hole sections 109 are changed according to the interval from the center point C.

In the case of FIG. 1, the interval L4 of the small hole 109b of the light-transmitting hole sections 109 present at the most distant section from the center point C is longer than the interval L1. Therefore, when light is radiated from only the small hole 109b of the light-transmitting sections 109 at the most distant section, a point where brightness is the highest is the center point C. However, the light is irradiated to positions more distant than the light source 101 and the light source 102. Therefore, the light-transmitting hole section 109 is also disposed in an area at the interval L3 from the center point C. Further, the light-transmitting hole section 109 present at the interval L3 is the large hole 109a larger than the size of the small hole 109b present at the interval L4. Consequently, the shapes of the brightness distributions of the light source 101 and the light source 102 and the light-transmitting hole sections 109 can be set the same.

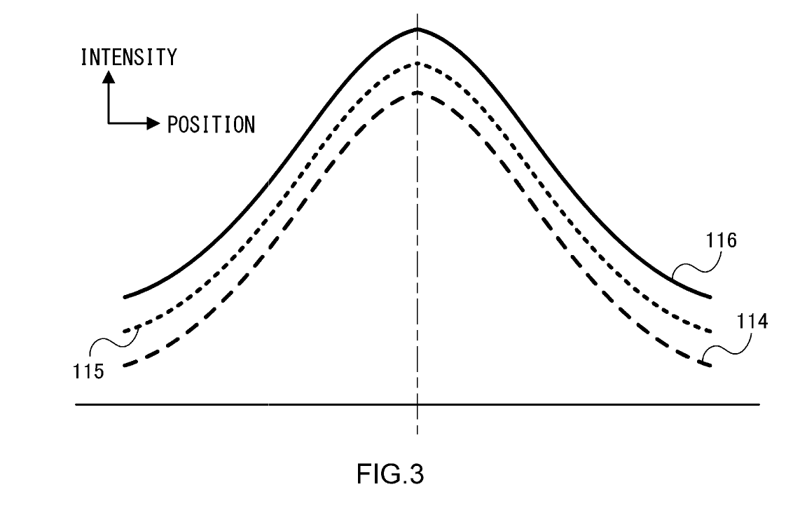

FIG. 3 is a diagram showing the brightness distributions generated by the light source 101, the light source 102, the light source 106, and the light-transmitting hole sections 109 configured as explained above.

In FIG. 3, the brightness distribution by the light source 101 is indicated by 114. The brightness distribution by the light source 102 is indicated by 115. The brightness distribution by the light-transmitting hole sections 109 is indicated by 116.

It is seen from FIG. 3 that the centers (the positions of the vertexes) of the brightness distribution characteristics substantially coincide with one another.

As explained above, in this embodiment, the light source 101, the light source 102, the light source 106, the reflecting sections 108, and the light-transmitting hole sections 109 are configured as explained above. Therefore, the center of the brightness distribution of the light emission by the light source 101 and the light source 102 and the center of the brightness distribution of the light radiated from the light-transmitting hole sections 109 in a case when the light source 106 emits light can be substantially matched.

Consequently, in the light source device in which both of the LEDs and the laser diodes are used, it is possible to uniformize a chromaticity distribution of a backlight device even when light source brightness is switched for each of the divided regions according to the local dimming control.

The inventors examined the influence of unevenness adjusting performance due to an interval between the light sources and the distance from the light sources (the substrate) to the diffusing section 112 disposed to face the substrate section 103. As a result, it was found that the effects of the present invention are obtained if a relation explained below holds even if the center of a brightness distribution of lights radiated from the light-transmitting hole sections 109 in the case when the light source 106 emits light and the center of a brightness distribution in a case when the light source 101 and the light source 102 emit lights slightly deviate from each other. This point is explained below.

In FIG. 1, an xy coordinate system having the origin at the center point C is defined on the substrate surface of the substrate section 103. A coordinate of the center of the brightness distribution of the lights radiated from the light-transmitting hole sections 109 in the case when the light source 106 emits light is represented as (x1, y1). A coordinate of the center of the brightness distribution in the case when the light source 101 and the light source 102 emit lights is represented as (x2, y2). The distance between the reflecting section 105 and the diffusing section 112 is represented as H. In such a case, a relation Δxy<0.2H (Δxy=((x1−x2)²⁺(y1−y2)²)^{1/2}) only has to hold. A distance H is the distance between the substrate on which the light source 101 and the light source 102 are mounted and the diffusing section 112. However, in this embodiment, since the reflecting section 105 is disposed on the surface of the substrate section 103, the distance H is set as the distance between the reflecting section 105 and the diffusing section 112.

With such a configuration, in the light source device in which both of the LEDs and the laser diodes are used, even when light source brightness is switched for each of the divided regions according to the local dimming control, it is possible to bring a chromaticity distribution of the backlight device close to a uniform chromaticity distribution.

In this embodiment, the light source device including the LEDs and the laser diodes is explained above. However, the light source device is not limited to this and only has to include a plurality of kinds of light sources having different directivity characteristics. Examples of a combination of the plurality of kinds of LEDs having the different directivity characteristics include a combination of a bullet-type LED (having high rectilinearity) and a surface mounting-type LED (a directivity characteristic is a Lambert distribution), a combination of a cold cathode tube (CCFL) and a laser, and a combination of an organic EL and a laser.

### Second Embodiment

A light source device 200 according to a second embodiment of the present invention is explained below.

In the first embodiment explained above, the configuration is explained in which the reflecting sections 108 and the light-transmitting hole sections 109 are set as the diffusing structure for diffusing the light of the light source 106 and reflecting the light to the diffusing section 112 side.

On the other hand, in this embodiment, a configuration is explained in which a light guide plate is added to the configuration in the first embodiment as a structure for diffusing light of the light source 106. Note that, in this embodiment, components different from the components in the first embodiment are explained. Explanation of components same as the components in the first embodiment is omitted.

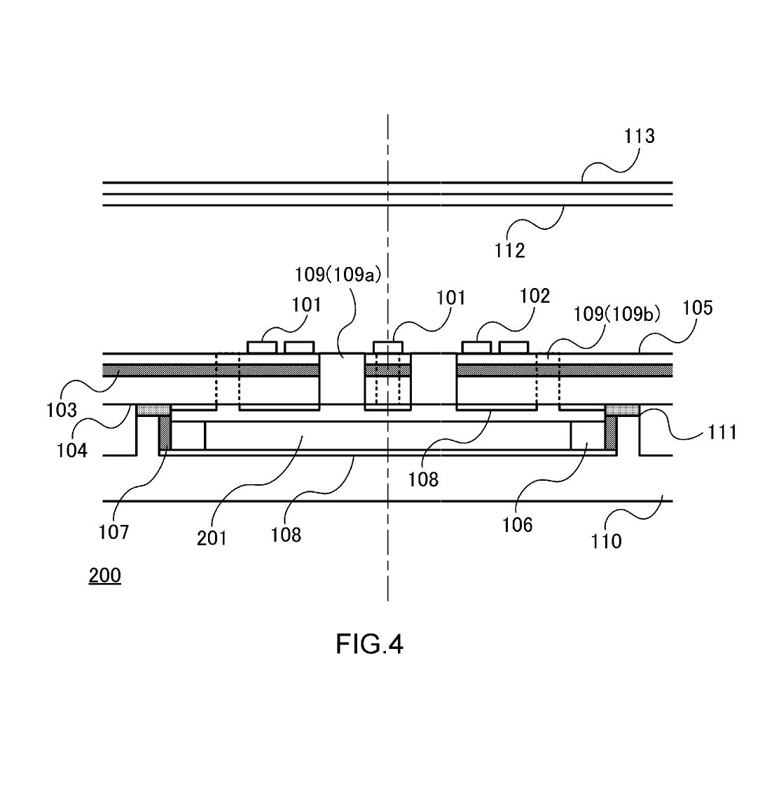

FIG. 4 is a diagram showing the schematic configuration of a main part of the light source device 200 according to this embodiment and is a sectional view of one lighting unit of the light source device 200.

The configuration of the light source device 200 in this embodiment is explained with reference to FIG. 4.

In this embodiment, the light source 106 is attached such that light emitted by the light source 106 is radiated in the horizontal direction. The light source 106 radiates the light toward a light guide plate 201 explained below.

The light guide plate 201 is a member for radiating the light received from the light source 106 to the diffusing section 112 side. A pattern for reflecting light such as a dot pattern is formed on the bottom surface section of the light guide plate 201. The dot pattern on the bottom surface section of the light guide plate 201 may be formed to irradiate the entire bottom surface at uniform brightness or may be formed such that brightness is high in the positions of the light-transmitting hole sections 109 explained below.

The reflecting section 108 is set on the bottom surface section of the light guide plate 201 and plays a role of reflecting light transmitted through the light guide plate 201 to the upper surface. The reflecting section 108 may be set on the bottom surface of the heat radiating section 104 to increase a rate of use of light radiated to the heat radiating section 104.

The dispositions of the light source 101, the light source 102, the light source 106, and the light-transmitting hole sections 109 in the light source device 200 according to this embodiment are explained.

The disposition of the light source 101 and the light source 102 are the same as the disposition in the first embodiment.

The disposition of the light-transmitting hole sections 109 is examined.

Light radiated from the light source 106 is sufficiently diffused by effects of the light guide plate 201 and the reflecting sections 108. Therefore, the light irradiated to the light-transmitting hole sections 109 is in a uniform state. The respective light transmitting holes of the light-transmitting hole sections 109 can be regarded as point light sources that are lit at the same brightness.

The light-transmitting hole sections 109 are disposed under the same idea as the first embodiment. In this embodiment, light is diffused by the light guide plate 201 rather than light diffusion in a space. Therefore, the reflecting section 108 present on the bottom surface section of the heat radiating section 104 is considered to often only have to have a small area.

Therefore, the light-transmitting hole sections 109 at a short distance from the center point C of the lighting unit can be formed as large as possible. The disposition, the number, and the size of the light-transmitting hole sections 109 may be determined according to the directivity of the light guide plate 201.

As explained above, in this embodiment as well, effects same as the effects of the first embodiment can be obtained.

The light source device according to the present invention is not limited to the first and second embodiments. Various changes may be added to the light source device without departing from the spirit of the present invention. For example, in the light-transmitting hole sections 109, the shape of the holes may be any shape (circular, rectangular, square, elliptical, or the like) as long as the center of a brightness distribution characteristic of light emitted by the light source 106 substantially coincides with the center of a brightness distribution characteristic of the light source 101 and the light source 102.

The light-transmitting hole sections 109 are disposed to face the substrate side on the opposite side of the mounting side of the light source 101 and the light source 102 with respect to the substrate section 103. However, the light-transmitting hole sections 109 are not limited to this and may be disposed in any positions as long as the center of a brightness distribution characteristic of light emitted by the light source 106 substantially coincides with the center of a brightness distribution characteristic of the light source 101 and the light source 102.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-157553, filed on Aug. 1, 2014 and Japanese Patent Application No. 2015-128893, filed on Jun. 26, 2015, which are hereby incorporated by reference herein in their entirety.

What is claimed is:

1. A light source device comprising:
a plurality of kinds of light sources having different directivity characteristics and including a first light source and a second light source having a directivity characteristic wider than a directivity characteristic of the first light source; and
a diffusing structure section for radiating light emitted by the first light source after diffusing the light, wherein
a position of a center of a first brightness distribution of light radiated from the diffusing structure section in a case when the first light source emits light is a position corresponding to a position of a center of a second brightness distribution in a case when the second light source emits light.

2. The light source device according to claim 1, wherein the center of the first brightness distribution substantially coincides with the center of the second brightness distribution.

3. The light source device according to claim 1, wherein a distribution shape of the first brightness distribution is a shape corresponding to a distribution shape of the second brightness distribution.

4. The light source device according to claim 3, wherein the distribution shape of the first brightness distribution substantially coincides with the distribution shape of the second brightness distribution.

5. The light source device according to claim 1, wherein
a substrate on which a plurality of the second light sources are mounted is provided, and
the plurality of second light sources are disposed on a circumference of a first circle on the substrate.

6. The light source device according to claim 5, wherein
in the diffusing structure section, a radiating hole, through which the light emitted from the first light source and diffused in the diffusing structure section is radiated to an outside of the diffusing structure section, is provided, and
in a case where viewed in a direction orthogonal to a surface on which the second light source is mounted in the substrate, a plurality of the radiating holes are disposed on a circumference of a second circle having a center same as a center of the first circle.

7. The light source device according to claim 6, wherein
each of the radiating holes is disposed on the circumference of the second circle and a circumference of a third circle having a center same as the center of the first circle and having a diameter larger than a diameter of the second circle, and
a size of the radiating hole disposed on the circumference of the second circle is larger than a size of the radiating hole disposed on the circumference of the third circle.

8. The light source device according to claim 6, wherein
the diffusing structure section is disposed such that the radiating hole faces the substrate side on an opposite side to a mounting side of the second light source with respect to the substrate, and
light from the radiating hole is radiated on the mounting side via the substrate.

9. The light source device according to claim 6, wherein a diffusing member that diffuses light is provided in the radiating hole.

10. The light source device according to claim 1, further comprising:
a substrate on which the second light source is mounted; and
a diffusing plate disposed to face the substrate and configured to diffuse light emitted by the second light source and light emitted by the first light source, and diffused in the diffusing structure section, and then radiated via the substrate, wherein
when an xy coordinate system is defined on a surface on which the second light source is mounted in the substrate, coordinates of the center of the first brightness distribution and the center of the second brightness distribution each are represented as (x1, y1) and (x2, y2), and a distance between the substrate and the diffusing plate is represented as H, a relation of Δxy<0.2H (Δxy=((x1−x2)²+(y1−y2)²)^{1/2}) is established.

11. The light source device according to claim 1, wherein the first light source is a laser diode.

12. The light source device according to claim 1, wherein the first light source is a green laser diode.

13. The light source device according to claim 1, wherein the second light source is a light emitting diode.

14. The light source device according to claim 1, further comprising:
a first heat radiating section configured to radiate heat generated in a case when the first light source emits light; and
a second heat radiating section configured to radiate heat generated in a case when the second light source emits light.

15. The light source device according to claim 14, wherein the second heat radiating section configures a part of the diffusing structure section.

16. The light source device according to claim 1, wherein a light guide plate for diffusing light emitted by the first light source is provided in the diffusing structure section.

17. The light source device according to claim 1, wherein the first light source and the second light source have different light emitting directions.

18. The light source device according to claim 1, wherein the light source further includes a third light source having a directivity characteristic wider than a directivity characteristic of the first light source.

19. The light source device according to claim 1, wherein the light source device is a backlight device used in a liquid crystal display apparatus.
